(19) United States
(12) Patent Application Publication
(10) Pub. No.: US 2012/0111840 A1
(43) Pub. Date: May 10, 2012

(54) LASER PROCESSING APPARATUS

(75) Inventor: Keiji Nomaru, Ota-Ku (JP)

(73) Assignee: DISCO CORPORATION, Tokyo (JP)

(21) Appl. No.: 13/281,971

(22) Filed: Oct. 26, 2011

(30) Foreign Application Priority Data
Nov. 4, 2010 (JP) 2010-247233

(51) Int. Cl. B23K 26/06

(52) U.S. Cl. 219/121.67

(57) ABSTRACT

A laser processing apparatus including a laser beam applying unit for applying a laser beam having a transmission wavelength to a workpiece held on a chuck table. The laser beam applying unit includes a laser beam oscillating unit for oscillating the laser beam, a focusing lens for focusing the laser beam oscillated by the laser beam oscillating unit, and a diffractive optic element interposed between the laser beam oscillating unit and the focusing lens. The laser beam oscillated by the laser beam oscillating unit is separated into a plurality of laser beams having different divergence angles by the diffractive optic element. The plurality of laser beams are next focused by the focusing lens to thereby form a plurality of focal points on the optical axis of the focusing lens.

### BACKGROUND OF THE INVENTION

1. Field of the Invention

The present invention relates to a laser processing apparatus for applying a laser beam having a transmission wavelength to a workpiece such as a semiconductor wafer to form modified layers inside the workpiece.

2. Description of the Related Art

In a semiconductor device fabrication process, a plurality of crossing division lines called streets are formed on the front side of a wafer including a suitable substrate such as a silicon substrate, sapphire substrate, silicon carbide substrate, lithium tantalate substrate, glass substrate, and quartz substrate to thereby partition a plurality of regions where devices such as ICs and LSIs are respectively formed. The wafer is cut along the streets to thereby divide the regions where the devices are formed from each other, thus obtaining the individual semiconductor devices. As a method of dividing the wafer, various methods using a laser beam have been proposed.

As a method of dividing a platelike workpiece such as a semiconductor wafer, a laser processing method using a pulsed laser beam having a transmission wavelength to the workpiece has been conducted. In this laser processing method, the pulsed laser beam is applied to the workpiece in the condition where the focal point of the pulsed laser beam is set inside the workpiece in a subject area to be divided. More specifically, a pulsed laser beam having a transmission wavelength (e.g., 1064 nm) to the workpiece is applied to the workpiece from one side thereof along the streets in the condition where the focal point of the pulsed laser beam is set inside the workpiece, thereby continuously forming a modified layer inside the workpiece along each street. Thereafter, an external force is applied to the workpiece along each street where the modified layer is formed to thereby reduce the strength, thereby breaking the workpiece along each street (see Japanese Patent No. 3408805, for example).

However, in order to accurately break the wafer along each street by applying an external force to the wafer, the thickness of the modified layer formed inside the wafer along each street must be increased, that is, the proportion of the modified layer in the thickness direction of the wafer must be increased. The thickness of each modified layer formed by the laser processing method mentioned above is 30 to 50 μm in the vicinity of the focal point of the pulsed laser beam. Accordingly, in order to increase the thickness of each modified layer, a plurality of modified layers must be formed inside the wafer along each street. To form a plurality of modified layers inside the wafer along each street, the focal point of the pulsed laser beam must be displaced in the thickness direction of the wafer, and the pulsed laser beam and the wafer must be relatively moved along each street repeatedly. Particularly in the case that the wafer has a large thickness (e.g., 600 μm), much time is required to form a modified layer having a thickness necessary for accurate breaking of the wafer.

To solve the above problem, there has been proposed a laser processing apparatus including a birefringent lens for separating a laser beam oscillated by laser beam oscillating means into ordinary light and extraordinary light. The ordinary light and the extraordinary light obtained by the birefringent lens are focused by a focusing lens to form a focal point of the ordinary light and a focal point of the extraordinary light. These two focal points are set at different positions deviated in the thickness direction of a workpiece, thereby simultaneously forming two modified layers inside the workpiece along each street (see Japanese Patent Laid-open No. 2007-931, for example).

### SUMMARY OF THE INVENTION

According to the laser processing apparatus disclosed in Japanese Patent Laid-open No. 2007-931 mentioned above, two modified layers can be formed simultaneously along each street so as to be layered in the thickness direction of the workpiece. However, three or more modified layers cannot be formed simultaneously along each street so as to be layered in the thickness direction of the workpiece. Accordingly, in the case that the thickness of the workpiece is large, the laser beam must be repeatedly applied along each street, so that this method is not always satisfactory from the viewpoint of productivity.

It is therefore an object of the present invention to provide a laser processing apparatus which can simultaneously form a plurality of modified layers inside a workpiece along each street so as to layer them in the thickness direction of the workpiece.

In accordance with an aspect of the present invention, there is provided a laser processing apparatus including a chuck table for holding a workpiece; laser beam applying means for applying a laser beam having a transmission wavelength to said workpiece held on said chuck table; and feeding means for relatively feeding said chuck table and said laser beam applying means; said laser beam applying means including laser beam oscillating means for oscillating said laser beam; a focusing lens for focusing said laser beam oscillated by said laser beam oscillating means; and a diffractive optic element interposed between said laser beam oscillating means and said focusing lens; wherein said laser beam oscillated by said laser beam oscillating means is separated into a plurality of laser beams having different divergence angles by said diffractive optic element, and said plurality of laser beams are next focused by said focusing lens to thereby form a plurality of focal points on the optical axis of said focusing lens.

In the laser processing apparatus of the present invention, the laser beam applying means for applying the laser beam to the workpiece held on the chuck table includes the laser beam oscillating means for oscillating the laser beam, the focusing lens for focusing the laser beam oscillated by the laser beam oscillating means, and the diffractive optic element interposed between the laser beam oscillating means and the focusing lens. The laser beam oscillated by the laser beam oscillating means is separated into the plural laser beams having different divergence angles by the diffractive optic element. The plural laser beams having different divergence angles are next focused by the focusing lens to thereby form the plural focal points on the optical axis of the focusing lens. Accordingly, a plurality of modified layers can be simultaneously formed so as to be layered in the thickness direction of the workpiece.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a laser processing apparatus according to the present invention;

FIG. 2 is a schematic block diagram showing the configuration of laser beam applying means included in the laser processing apparatus shown in FIG. 1;

FIG. 3 is a schematic view for illustrating the function of a diffractive optic element constituting the laser beam applying means shown in FIG. 2;

FIG. 4 is a perspective view of a semiconductor wafer as a workpiece;

FIG. 5 is a perspective view showing a condition that the semiconductor wafer shown in FIG. 4 is attached to the upper surface of a protective tape supported to an annular frame; and

FIGS. 6A and 6B are sectional side views for illustrating a modified layer forming step of forming modified layers inside the semiconductor wafer shown in FIG. 4 by using the laser processing apparatus shown in FIG. 1.

### DETAILED DESCRIPTION OF THE PREFERRED EMBODIMENT

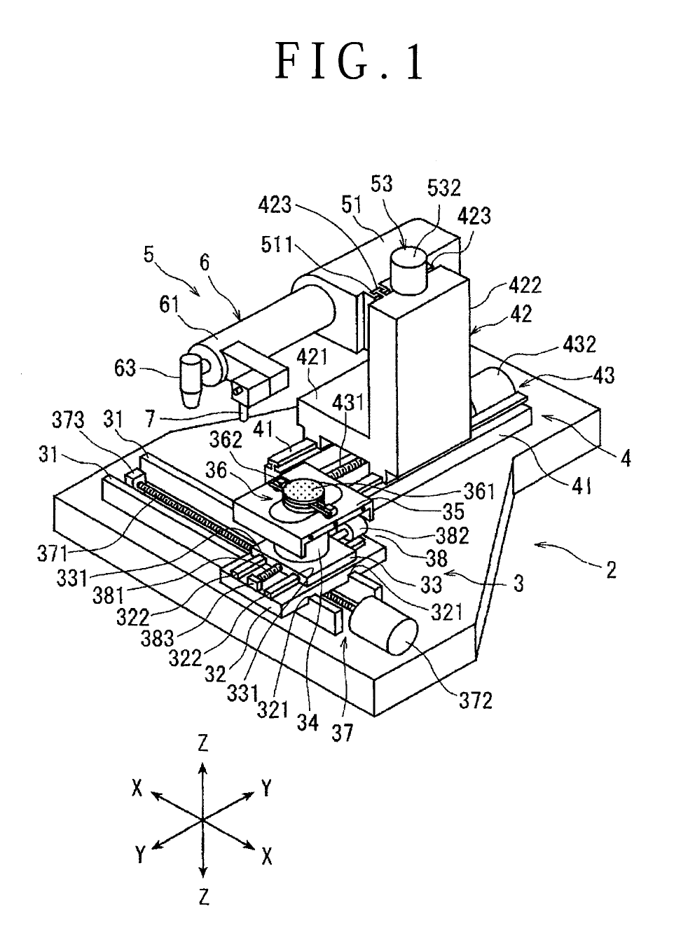

A preferred embodiment of the laser processing apparatus according to the present invention will now be described in detail with reference to the attached drawings. FIG. 1 is a perspective view of a laser processing apparatus according to a preferred embodiment of the present invention. The laser processing apparatus shown in FIG. 1 includes a stationary base 2, a chuck table mechanism 3 for holding a workpiece, the chuck table mechanism 3 being provided on the stationary base 2 so as to be movable in a feeding direction (X direction) shown by an arrow X, a laser beam applying unit supporting mechanism 4 provided on the stationary base 2 so as to be movable in an indexing direction (Y direction) shown by an arrow Y perpendicular to the X direction, and a laser beam applying unit 5 provided on the laser beam applying unit supporting mechanism 4 so as to be movable in a focal position adjusting direction (Z direction) shown by an arrow Z perpendicular to a holding surface of a chuck table to be hereinafter described.

The chuck table mechanism 3 includes a pair of guide rails 31, 31 provided on the stationary base 2 so as to extend parallel to each other in the X direction, a first slide block 32 provided on the guide rails 31 so as to be movable in the X direction, a second slide block 33 provided on the first slide block 32 so as to be movable in the Y direction, a cover table 35 supported by a cylindrical member 34 standing on the second slide block 33, and a chuck table 36 as workpiece holding means. The chuck table 36 has a vacuum chuck 361 formed of a porous material. A workpiece such as a disk-shaped semiconductor wafer is adapted to be held under suction on the vacuum chuck 361 as a workpiece holding surface by operating suction means (not shown). The chuck table 36 is rotatable by a pulse motor (not shown) provided in the cylindrical member 34. Further, the chuck table 36 is provided with clamps 362 for fixing an annular frame (not shown) supporting the wafer.

The lower surface of the first slide block 32 is formed with a pair of guided grooves 321, 321 for slidably engaging the pair of guide rails 31, 31 mentioned above. A pair of guide rails 322, 322 are provided on the upper surface of the first slide block 32 so as to extend parallel to each other in the Y direction. Accordingly, the first slide block 32 is movable in the X direction along the guide rails 31, 31 by the slidable engagement of the guided grooves 321, 321 with the guide rails 31, 31. The chuck table mechanism 3 further includes feeding means 37 provided by a ball screw mechanism for moving the first slide block 32 in the X direction along the guide rails 31, 31. The feeding means 37 includes an externally threaded rod 371 extending parallel to the guide rails 31, 31 so as to be interposed therebetween and a pulse motor 372 as a drive source for rotationally driving the externally threaded rod 371. The externally threaded rod 371 is rotatably supported at one end thereof to a bearing block 373 fixed to the stationary base 2 and is connected at the other end to the output shaft of the pulse motor 372 so as to receive the torque thereof. The externally threaded rod 371 is engaged with a tapped through hole formed in an internally threaded block (not shown) projecting from the lower surface of the first slide block 32 at a central portion thereof. Accordingly, the first slide block 32 is moved in the X direction along the guide rails 31, 31 by operating the pulse motor 372 to normally or reversely rotate the externally threaded rod 371.

The lower surface of the second slide block 33 is formed with a pair of guided grooves 331, 331 for slidably engaging the pair of guide rails 322, 322 provided on the upper surface of the first slide block 32 as mentioned above. Accordingly, the second slide block 33 is movable in the Y direction along the guide rails 322 by the slidable engagement of the guided grooves 331, 331 with the guide rails 322, 322. The chuck table mechanism 3 according to the embodiment further includes first indexing means 38 provided by a ball screw mechanism for moving the second slide block 33 in the Y direction along the pair of guide rails 322, 322 provided on the first slide block 32. The first indexing means 38 includes an externally threaded rod 381 extending parallel to the guide rails 322 and 322 so as to be interposed therebetween and a pulse motor 382 as a drive source for rotationally driving the externally threaded rod 381. The externally threaded rod 381 is rotatably supported at one end thereof to a bearing block 383 fixed to the upper surface of the first slide block 32 and is connected at the other end to the output shaft of the pulse motor 382 so as to receive the torque thereof. The externally threaded rod 381 is engaged with a tapped through hole formed in an internally threaded block (not shown) projecting from the lower surface of the second slide block 33 at a central portion thereof. Accordingly, the second slide block 33 is moved in the Y direction along the guide rails 322, 322 by operating the pulse motor 382 to normally or reversely rotate the externally threaded rod 381.

The laser beam applying unit supporting mechanism 4 includes a pair of guide rails 41, 41 provided on the stationary base 2 so as to extend parallel to each other in the Y direction and a movable support base 42 provided on the guide rails 41, 41 so as to be movable in the Y direction. The movable support base 42 is composed of a horizontal portion 421 slidably supported to the guide rails 41, 41 and a vertical portion 422 extending vertically upward from the upper surface of the horizontal portion 421. Further, a pair of guide rails 423, 423 are provided on one side surface of the vertical portion 422 so as to extend parallel to each other in the Z direction. The laser beam applying unit supporting mechanism 4 further includes second indexing means 43 provided by a ball screw mechanism for moving the movable support base 42 in the Y direction along the guide rails 41, 41. The second indexing means 43 includes an externally threaded rod 431 extending parallel to the guide rails 41, 41 so as to be interposed therebetween and a pulse motor 432 as a drive source for rotationally driving the externally threaded rod 431. The externally threaded rod 431 is rotatably supported at one end thereof to a bearing block (not shown) fixed to the stationary base 2 and is connected at the other end to the output shaft of the pulse motor 432 so as to receive the torque thereof. The externally threaded rod 431 is engaged with a tapped through hole formed in an internally threaded block (not shown) projecting from the lower surface of the horizontal portion 421 constituting the movable support base 42 at a central portion of the horizontal portion 421. Accordingly, the movable support base 42 is moved in the Y direction along the guide rails 41, 41 by operating the pulse motor 432 to normally or reversely rotate the externally threaded rod 431.

The laser beam applying unit 5 includes a unit holder 51 and pulsed laser beam applying means 6 mounted to the unit holder 51. The unit holder 51 is formed with a pair of guided grooves 511, 511 for slidably engaging the pair of guide rails 423, 423 provided on the vertical portion 422 of the movable support base 42. Accordingly, the unit holder 51 is supported to the movable support base 42 so as to be movable in the Z direction by the slidable engagement of the guided grooves 511, 511 with the guide rails 423, 423.

The laser beam applying unit 5 further includes focal position adjusting means 53 for moving the unit holder 51 along the guide rails 423, 423 in the Z direction. Like the feeding means 37, the first indexing means 38, and the second indexing means 43, the focal position adjusting means 53 is provided by a ball screw mechanism. That is, the focal position adjusting means 53 includes an externally threaded rod (not shown) extending parallel to the guide rails 423, 423 so as to be interposed therebetween and a pulse motor 532 as a drive source for rotationally driving this externally threaded rod. Accordingly, the unit holder 51 and the pulsed laser beam applying means 6 are moved in the Z direction along the guide rails 423, 423 by operating the pulse motor 532 to normally or reversely rotate this externally threaded rod. In this preferred embodiment, when the pulse motor 532 is normally operated, the pulsed laser beam applying means 6 is moved upward, whereas when the pulse motor 532 is reversely operated, the pulsed laser beam applying means 6 is moved downward.

The pulsed laser beam applying means 6 includes a cylindrical casing 60 fixed to the unit holder 51 so as to extend in a substantially horizontal direction. Imaging means 7 is mounted on the front end portion of the cylindrical casing 60. The imaging means 7 functions to detect a subject area of the workpiece to be laser-processed by the pulsed laser beam applying means 6. The imaging means 7 includes an imaging device (infrared CCD), and an image signal output from the imaging means 7 is transmitted to control means (not shown).

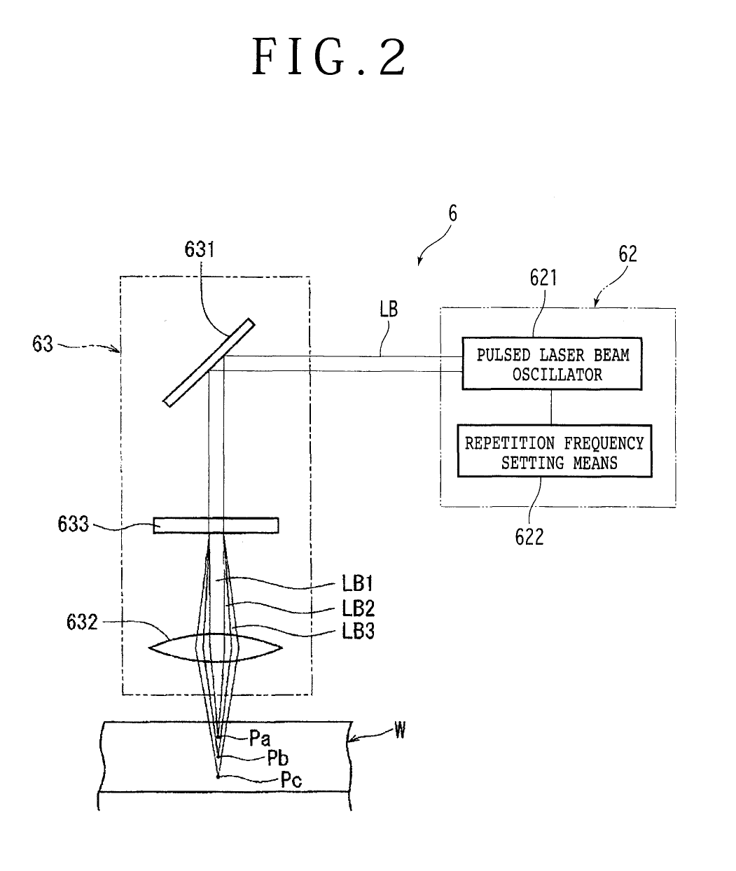

As shown in FIG. 2, the pulsed laser beam applying means 6 includes pulsed laser beam oscillating means 62 provided in the casing 61 for oscillating a pulsed laser beam LB and focusing means (condenser) 63 for focusing the pulsed laser beam LB oscillated by the pulsed laser beam oscillating means 62 and applying this pulsed laser beam LB to a workpiece W held on the chuck table 36. The pulsed laser beam oscillating means 62 includes a pulsed laser beam oscillator 621 provided by a YAG laser oscillator or a YVO4 laser oscillator and repetition frequency setting means 622 connected to the pulsed laser beam oscillator 621. The pulsed laser beam oscillator 621 functions to oscillate the pulsed laser beam LB having a predetermined frequency set by the repetition frequency setting means 622. The repetition frequency setting means 622 functions to set the repetition frequency of the pulsed laser beam LB to be oscillated by the pulsed laser beam oscillator 621.

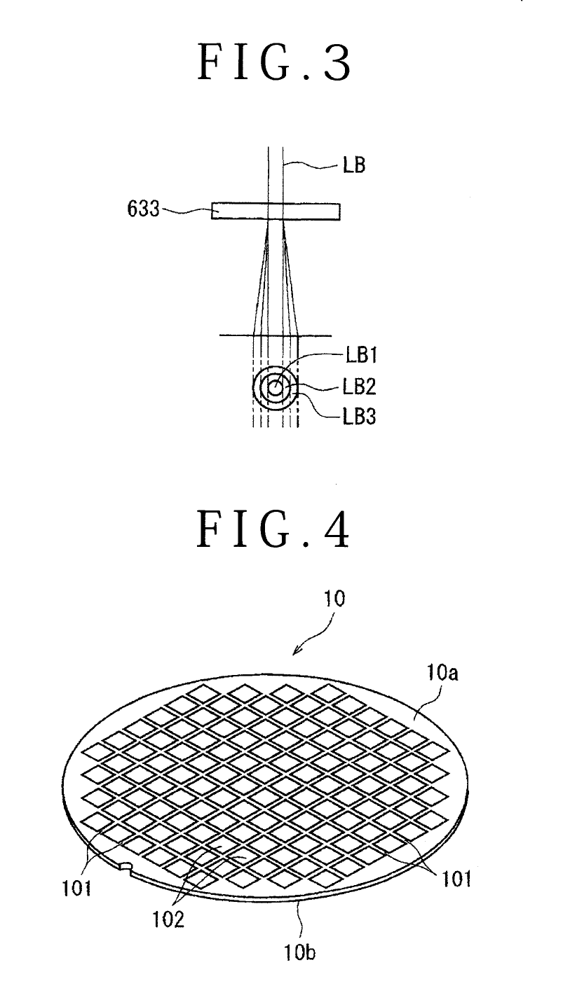

The focusing means 63 is mounted at the front end of the casing 61. The focusing means 63 includes a direction changing mirror 631 for changing the traveling direction of the pulsed laser beam LB oscillated by the pulsed laser beam oscillating means 62 to a downward direction as viewed in FIG. 2, a focusing lens 632 for focusing the pulsed laser beam reflected by the direction changing mirror 631 and applying this pulsed laser beam to the workpiece W held on the chuck table 36, and a diffractive optic element (DOE) 633 interposed between the direction changing mirror 631 and the focusing lens 632. As shown in FIGS. 2 and 3, the diffractive optic element 633 functions to separate the pulsed laser beam oscillated by the pulsed laser beam oscillating means 62 and reflected by the direction changing mirror 631 into a plurality of pulsed laser beams LB1, LB2, and LB3 having different divergence angles (e.g., three pulsed laser beams in this preferred embodiment shown in FIGS. 2 and 3) and apply these pulsed laser beams LB1, LB2, and LB3 to the focusing lens 632. The focusing lens 632 functions to focus the plural (three in this preferred embodiment shown in FIG. 2) pulsed laser beams LB1, LB2, and LB3 having different divergence angles, thereby forming a plurality of (three in this preferred embodiment shown in FIG. 2) focal points Pa, Pb, and Pc on the optical axis of the focusing lens 632.

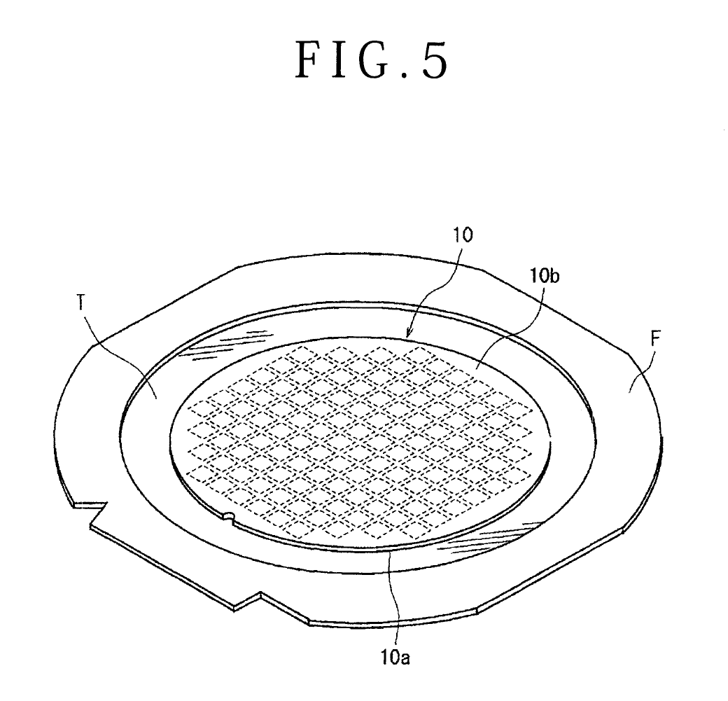

The operation of the laser processing apparatus as configured above according to this preferred embodiment will now be described. FIG. 4 is a perspective view of a semiconductor wafer 10 as a workpiece to be processed by the laser processing apparatus mentioned above. The semiconductor wafer 10 is formed from a silicon substrate having a thickness of 600 μm, for example. A plurality of crossing streets 101 are formed on the front side 10a of the semiconductor wafer 10 to thereby partition a plurality of rectangular regions where a plurality of devices 102 such as ICs and LSIs are respectively formed. Prior to forming a modified layer inside the semiconductor wafer 10 along each street 101, the front side 10a of the semiconductor wafer 10 is attached to the upper surface of a protective tape T supported to an annular frame F as shown in FIG. 5 (protective tape attaching step). The protective tape T is formed from a synthetic resin sheet such as a polyolefin sheet. Accordingly, the back side 10b of the semiconductor wafer 10 attached to the upper surface of the protective tape T is oriented upward as shown in FIG. 5.

In forming the modified layer inside the semiconductor wafer 10 along each street 101 by using the laser processing apparatus shown in FIG. 1, the semiconductor wafer 10 is placed on the chuck table 36 of the laser processing apparatus in the condition where the protective tape T attached to the semiconductor wafer 10 comes into contact with the upper surface of the chuck table 36. In this condition, the suction means (not shown) connected to the chuck table 36 is operated to thereby hold the semiconductor wafer 10 through the protective tape T on the chuck table 36 under suction (wafer holding step). Accordingly, the back side 10b of the semiconductor wafer 10 held on the chuck table 36 is oriented upward. Further, the annular frame F supporting the semiconductor wafer 10 through the protective tape T is fixed by the clamps 362 provided on the chuck table 36. Thereafter, the feeding means 37 is operated to move the chuck table 36 holding the semiconductor wafer 10 to a position directly below the imaging means 7.

In the condition where the chuck table 36 is positioned directly below the imaging means 7, an alignment operation is performed by the imaging means 7 and the control means (not shown) to detect a subject area of the semiconductor wafer 10 to be laser-processed. More specifically, the imaging means 7 and the control means perform imaging processing such as pattern matching for making the alignment of the streets 101 extending in a first direction on the semiconductor wafer 10 and the focusing means 63 of the laser beam applying means 6 for applying the laser beam along the streets 101, thus performing the alignment of a laser beam applying position (alignment step). This alignment operation is performed similarly for the other streets 101 extending in a second direction perpendicular to the first direction mentioned above on the semiconductor wafer 10. Although the front side 10a of the semiconductor wafer 10 on which the streets 101 are formed is oriented downward, the streets 101 can be imaged from the back side 10b of the semiconductor wafer 10 through the substrate because the imaging means 7 includes an imaging device provided by an infrared CCD as mentioned above.

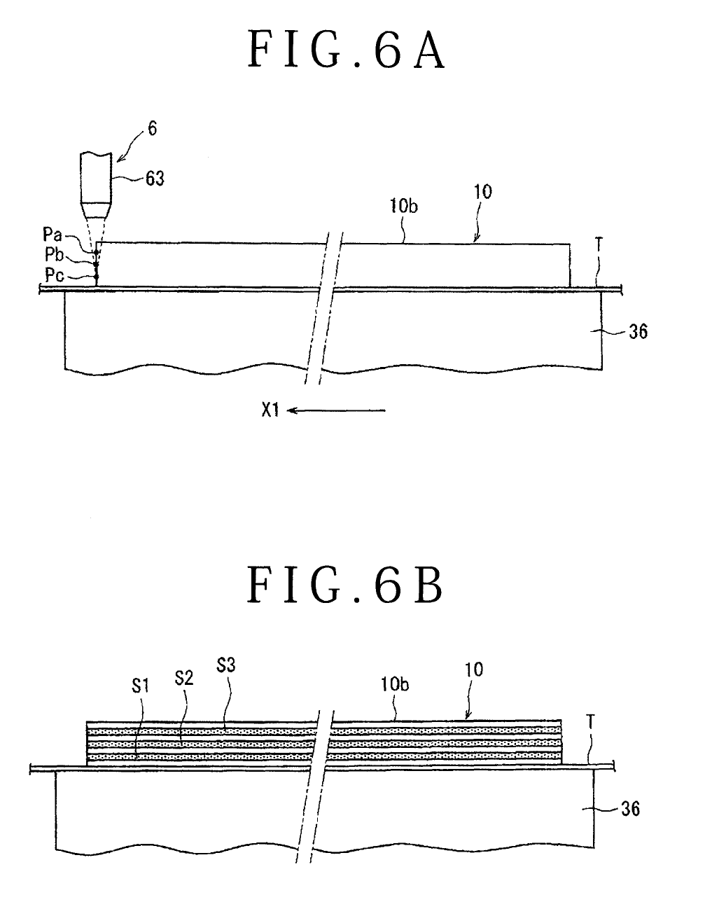

After performing the alignment step to detect all of the streets 101 formed on the front side 10a of the semiconductor wafer 10 held on the chuck table 36, the feeding means 37 and the first indexing means 38 are operated to move the chuck table 36 to a laser beam applying area where the focusing means 63 of the laser beam applying means 6 is positioned, thereby positioning one end (left end as viewed in FIG. 6A) of a predetermined one of the streets 101 extending in the first direction directly below the focusing means 63 of the laser beam applying means 6 as shown in FIG. 6A. Thereafter, the focal position adjusting means 53 is operated to adjust the three focal points Pa, Pb, and Pc of the three pulsed laser beams LB1, LB2, and LB3 to be applied from the focusing means 63 so that these focal points Pa, Pb, and Pc are set at predetermined positions inside the semiconductor wafer 10 as shown in FIG. 6A. Thereafter, the pulsed laser beam oscillating means 62 of the laser beam applying means 6 is operated to apply a pulsed laser beam having a transmission wavelength to the semiconductor wafer 10 from the focusing means 63 to the semiconductor wafer 10, and the chuck table 36 is moved in the direction shown by an arrow X1 in FIG. 6A at a predetermined feed speed. When the other end (right end as viewed in FIG. 6B) of the predetermined street 101 reaches the position directly below the focusing means 63 as shown in FIG. 6B, the application of the pulsed laser beams LB1, LB2, and LB3 is stopped and the movement of the chuck table 36 is also stopped. As a result, three modified layers S1, S2, and S3 are simultaneously formed inside the semiconductor wafer 10 at different depths along the predetermined street 101 as shown in FIG. 6B (modified layer forming step).

For example, the modified layer forming step mentioned above is performed under the following processing conditions.

Light source: LD pumped Q-switched Nd: YAG pulsed laser

Wavelength: 1064 nm

Average power: 1.0 W

Repetition frequency: 100 kHz

Focused spot diameter: φ1 to 1.5 μm

Work feed speed: 100 mm/s

After performing the modified layer forming step along all of the streets 101 extending in the first direction on the semiconductor wafer 10, the chuck table 36 holding the semiconductor wafer 10 is rotated 90° to similarly perform the modified layer forming step along all of the other streets 101 extending in the second direction perpendicular to the first direction.

In this manner, the modified layer forming step is performed along all of the streets 101 extending in the first and second directions on the semiconductor wafer 10 to thereby form the modified layers S1, S2, and S3 inside the semiconductor wafer 10 along each street 101. Thereafter, the semiconductor wafer 10 is subjected to a wafer dividing step of applying an external force to the semiconductor wafer 10 along each street 101 to thereby break the semiconductor wafer 10 along each street 101 where the modified layers S1, S2, and S3 are formed.

Having thus described the specific preferred embodiment of the present invention, it should be noted that the present invention is not limited to the above preferred embodiment, but various modifications may be made within the scope of the present invention. For example, while the diffractive optic element 633 used in this preferred embodiment functions to separate a pulsed laser beam into three pulsed laser beams having different divergence angles, a diffractive optic element having a function of separating a pulsed laser beam into four or more pulsed laser beams having different divergence angles may be used to thereby simultaneously form four or more modified layers along each street.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser processing apparatus comprising:
a chuck table for holding a workpiece;
laser beam applying means for applying a laser beam having a transmission wavelength to said workpiece held on said chuck table; and
feeding means for relatively feeding said chuck table and said laser beam applying means;
said laser beam applying means including:
laser beam oscillating means for oscillating said laser beam;
a focusing lens for focusing said laser beam oscillated by said laser beam oscillating means; and
a diffractive optic element interposed between said laser beam oscillating means and said focusing lens;
wherein said laser beam oscillated by said laser beam oscillating means is separated into a plurality of laser beams having different divergence angles by said diffractive optic element, and said plurality of laser beams are next focused by said focusing lens to thereby form a plurality of focal points on the optical axis of said focusing lens.
